(19) United States
(12) Patent Application Publication
(10) Pub. No.: US 2008/0152750 A1
(43) Pub. Date: Jun. 26, 2008

(54) MOLDING APPARATUS FOR OPTICAL ELEMENT

(75) Inventor: Shinji TANAKA, Chiyoda-ku (JP)

Correspondence Address: OBLON, SPIVAK, MCCLELLAND MAIER & NEUSTADT, P.C., 1940 DUKE STREET, ALEXANDRIA, VA, 22314, US

(73) Assignee: ASAHI GLASS COMPANY LIMITED, Chiyoda-ku (JP)

(21) Appl. No.: 11/963,296

(22) Filed: Dec. 21, 2007

Related U.S. Application Data
(63) Continuation of application No. PCT/JP2006/312827, filed on Jun. 27, 2006.

(30) Foreign Application Priority Data
Jun. 30, 2005 (JP) 2005-192528

(51) Int. Cl. B29C 43/00

(52) U.S. Cl. 425/357

(57) ABSTRACT

The present invention provides an apparatus for molding optical element, which pressurizes top and bottom molds in a state that they are always maintained to be parallel and their axes are aligned into a single line, and which can mold a product having a predetermined dimension precisely even if it pressurizes a plurality of molds at the same time.

An apparatus for molding optical element, which comprises a pressurizing apparatus 4 for pressurizing a mold constituted by a top mold 33, a bottom mold 33 and a body mold 32, in which a molding material 5 is disposed, in a vertical direction to form an optical element, the apparatus for molding optical elements being characterized by further comprising a pressuring plate 21 attached to a leading edge of the pressurizing apparatus 4, a flat plate 23 movable in a vertical direction for pressurizing the mold 3, and an elastic member 22 disposed between the pressurizing plate 21 and the flat plate 23, and elastically deformable with its top face 22b and bottom face 22c always maintained to be parallel with each other.

### TECHNICAL FIELD

The present invention relates to a molding apparatus for press-molding optical elements such as high-precision glass lenses used for optical instruments, in particular to a molding apparatus capable of pressurizing a plurality of molds by a single press-molding apparatus to mold high-precision optical elements.

### BACKGROUND ART

Heretofore, an apparatus for molding high-precision optical elements to be used for e.g. optical instruments, is configured to sandwich a heated and softened lens molding material between a pair of top and bottom molds fitted into a cylindrical body mold, and pressurize them in vertical direction to carry out molding.

At a time of press-molding a glass molding material, the glass molding material is molded into a shape corresponding to molding surfaces of the top mold and the bottom mold. In order to obtain an optical element having a predetermined accuracy, it is essential to transfer the molding surface accurately to the glass molding material, and for this purpose, it is important to pressurize the top and bottom molds in a state that their axes are aligned into one straight line and the top and bottom molds are always maintained to be in parallel, and to mold so that the distance between the top and bottom molds becomes an accurate dimension corresponding to the thickness of the product.

However, at a time of pressurizing the top mold sliding in the cylindrical body mold, it is difficult to pressurize the top mold over the entire stroke with the axis of the top mold maintained vertical and aligned to the axis of the bottom mold since the top mold tends to incline slightly due to a clearance between the top mold and the body mold. Accordingly, even if a pressurizing direction is inclined in the middle of the stroke and axes of the top and bottom molds are aligned at a final molding position, the quality of molded product may have eccentricity. Particularly, in order to carry out mass production, for example, it is necessary to dispose a plurality of molds on a fixed flat plate and to simultaneously pressurize the plurality of molds from the top side by a pressurizing plate of a single pressurizing apparatus. In this case, it is extremely difficult to carry out the pressurizing in a state that top and bottom molds of each mold are kept in parallel.

Further, molds each constituted by a top mold, a bottom mold and a body mold, inevitably have variations in the dimension from a production reason. Accordingly, when a plurality of molds are disposed on a fixed flat plate and they are pressurized by a single pressurizing plate from the top at the same time in parallel, due to variations of vertical dimensions of the molds, variations occur in the distances between molding surfaces of the top molds and the bottom molds. Accordingly, variations occur in pressurizing forces to the molds and variations occur in the qualities and the dimensions of the products. In this case, it is possible to absorb the variation of the mold dimensions and to pressurize with a uniform pressurizing force by pressurizing the pressurizing plate via an elastic member. However, in this case, the pressurizing plate inclines according to the difference of the heights of molds, and axes in a mold are shifted to deteriorate molding accuracy.

As molding apparatuses for mass-producing precision optical elements which solve such problems, apparatuses disclosed in Patent Documents 1 to 3 have been proposed.

Apparatuses of Patent Document 1 and Patent Document 2 each pressurizes with forces produced by elastic members and has centering functions, but its pressurizing surfaces are not always maintained to be parallel. Further, Patent Document 3 discloses an apparatus which has a bellows to carry out fluid-pressing to make pressures to a plurality of molds constant, so as to equalize the pressures to the molds. This apparatus has a complicated structure and is expensive, and also in this case, the pressurizing surfaces are not always maintained to be parallel.

The above-mentioned apparatuses disclosed in the Patent Documents, are each an apparatus for equalizing the pressures at a time of pressurizing, and not an apparatus to keep the pressurizing surface always in parallel.

Patent Document 1: Japanese Patent No. 3042411

Patent Document 2: Japanese Patent No. 3183638

Patent Document 3: Japanese Patent No. 3177753

### DISCLOSURE OF THE INVENTION

### Problems to be Solved by the Invention

The present invention has been made considering the above-mentioned prior arts, and it is an object of the present invention to provide an apparatus for producing optical elements, which can pressurize top and bottom molds while maintaining them always in parallel, which can align their axes into a single line, and which can precisely mold a product of predetermined dimensions even if a plurality of molds are pressurized at the same time.

### Means for Solving the Problems

The present invention has the following gists.

(1) An apparatus for molding optical element, which comprises a pressurizing apparatus for pressurizing a mold constituted by a top mold, a bottom mold and a body mold in which a molding material is disposed, in a vertical direction to form an optical element; the apparatus for molding optical elements being characterized by further comprising a pressuring plate attached to a leading edge of the pressurizing apparatus, a flat plate movable in the vertical direction for pressurizing the mold, and an elastic member disposed between the pressurizing plate and the flat plate, and elastically deformable with its top face and bottom face always maintained to be parallel with each other.

(2) The apparatus for molding optical element according to the above (1), wherein the flat plate and the elastic member are disposed for each mold and a plurality of molds are pressurized simultaneously by the single pressurizing plate attached to the single pressurizing apparatus.

(3) The apparatus for molding optical element according to the above (1) or (2), wherein the elastic member has a parallel flat plate structure.

(4) The apparatus for molding optical element according to the above (3), wherein the elastic member having a parallel flat plate structure has two rectangular hollow holes in the left and right portions respectively, whereby the elastic member deforms with its top face and bottom face always maintained to be parallel with each other.

(5) The apparatus for molding optical element according to any one of the above (1) to (4), wherein the elastic member is disposed in the upper side of the mold.

(6) The apparatus for molding optical element according to any one of the above (1) to (5), wherein the optical element is an optical lens and the apparatus for molding optical element is employed in a molding step in a production apparatus for the optical lens.

(7) The apparatus for molding optical element according to the above (6), wherein the optical lens is an optical lens made of a glass or a plastic.

(8) The apparatus for molding optical element according to any one of the above (1) to (7), wherein the pressurizing plate, the flat plate, the elastic member and the mold is present in a non-oxidative atmosphere.

### EFFECTS OF THE INVENTION

According to the embodiment of the above (1), by pressurizing a mold via an elastic member elastically deforming with its top surface and bottom surface always maintained to be in parallel, axes of the molds do not incline over an entire stroke of the pressing step. Accordingly, it is possible to accurately transfer a shape of a mold to a molding material, and to mold an optical element having stable and high performance.

According to the embodiment of the above (2), by pressurizing molds with respective elastic members, it is possible to absorb variation of dimensions of the molds, and accordingly, even if a plurality of molds are pressurized at the same time, each mold is pressurized with a predetermined pressure corresponding to the respective dimensions. Moreover, since each mold is maintained so that its top mold and bottom mold are always in parallel, it is possible to pressurize the top mold and the bottom mold so that their axes do not incline from each other and they are aligned into a single line during the pressurizing stroke. Accordingly, it is possible to mold a plurality of products each having accurate dimensions at the same time.

According to the embodiment of the above (3), by forming the elastic member to have a parallel flat plate structure, the elastic member can produce secure parallel movement by a simple structure. Further, according to the embodiment of the above (4), by forming two hollow holes in the left and right portions respectively, it is possible to make the elastic member elastically deform with the top surface and bottom surface more surely maintained to be in parallel.

According to the embodiment of the above (6), it is possible to mass-produce high-quality and high-precision optical lenses for precision instruments, with simple structure.

Further, according to the embodiment of the above (8), it is possible to prevent oxidization of e.g. a mold in the molding apparatus.

### BRIEF DESCRIPTION OF DRAWINGS

FIG. 1: An explanation view of a parallel flat plate structure.

FIG. 2: A vertical cross-sectional view showing an embodiment of a molding apparatus of the present invention.

FIG. 3: A plan view showing a production apparatus for optical elements using the present invention.

### EXPLANATION OF NUMERALS

1: production apparatus, 2: molding apparatus, 3: mold, 4: pressurizing apparatus, 5: molding material, 6: product, 7a, 7b: mold conveying apparatus, 8a: chuck, 8b: mold centering apparatus, 9: cantilever, 10: chamber, 11: conveying path, 11a: outgoing path, 11b, 11d: connecting path, 11c: returning path, 12: molding material supply zone, 13: mold reassembly zone, 14: heating zone, 15: molding zone, 16: cooling zone, 17: product retrieving zone, 18: mold exchange chamber, 19: partition wall, 21: pressurizing plate, 22: elastic member, 22a: hollow hole, 22b: upper face, 22c: lower face, 23: movable flat plate, 24: fixed flat plate, 31: top mold, 32: body mold, 33: bottom mold, 41: cylinder, 42: guide, 50: molding material chamber, 51: molding material tray, 52: molding material supply robot, 60: product chamber, 61: product tray, 62: product retrieving robot, 90: hollow hole, 91: leading edge face, 92: fixed face, 93, 94: beam portion.

### BEST MODE FOR CARRYING OUT THE INVENTION

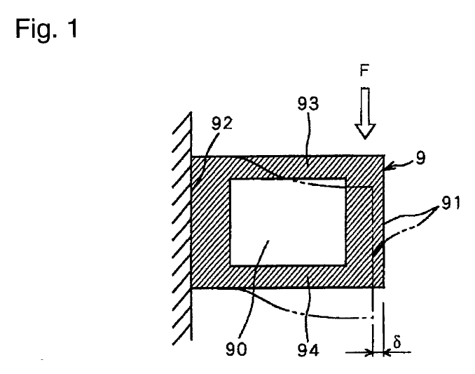

FIG. 1 is a schematic view showing a parallel flat plate. As shown in the figure, when e.g. a rectangular hollow hole 90 is present in a cantilever 9 having a rectangular cross section, a beam portion 93 in the upper side of the hollow hole 90 and a beam portion 94 in the lower side of the hollow hole 90 deform like a pair of parallel flat plates. Namely, when an external force F is applied, the beam portions deform as shown by the chain double-dashed lines, and a leading edge face 91 of the cantilever 9 shifts by δ in horizontal direction. Here, the parallel flat plate has a characteristic that the leading edge face 91 shifts while it is maintained to be in parallel with a fixed face 92. Accordingly, the top face and the bottom face of the leading edge portion of the cantilever 9 shift with their positions maintained to be horizontal. Namely, the top face and the bottom face are always in parallel with the top face and the bottom face of no external force application.

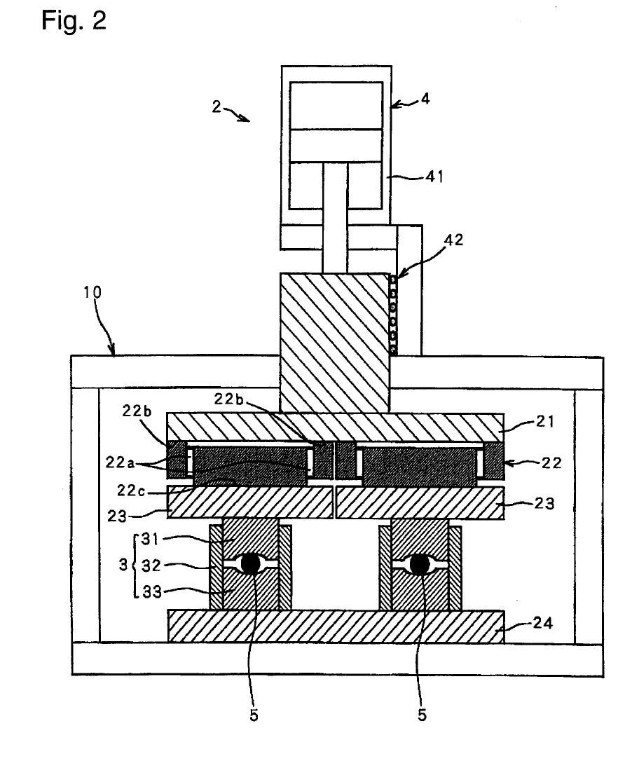

FIG. 2 shows an embodiment of a molding apparatus of the present invention. In a molding apparatus 2, a molding step of optical elements such as an optical lens made of a glass or a plastic is carried out in a chamber 10 filled with a non-oxidative gas, for example, an inert gas such as nitrogen, and sealed to prevent oxidation of e.g. a mold.

A fixed flat plate 24 is placed on a floor face of the chamber 10. The fixed flat plate 24 may be disposed for each mold 3 or the fixed flat plate 24 may be shared by a plurality of molds 3.

On the fixed flat plate 24, two molds 3 each having a molding material 5 being a glass ball disposed inside, are placed in parallel in this example. Each of the molds 3 is constituted by a cylindrical body mold 32, a bottom mold 33 fixed in the body mold 32 and a top mold 31 slidable in the body mold 32. The lower face of the top mold 31 and the upper face of the bottom mold 33 are molding faces, and the molding material 5 is disposed between them and pressed by a pressurizing apparatus 4 to be described later, to be formed into an optical element.

On the mold 3, a movable flat plate 23 is placed and on the top of it, an elastic member 22 having a parallel flat plate structure is placed. The movable flat plate 23 and the elastic member 22 are provided for each mold 3.

Each elastic member 22 has elasticity deformable in a vertical direction in response to an external force, and in FIG. 2, upper faces 22b on left and right ends contact with a pressurizing plate 21 and a lower face 22c in the central portion contact with a movable flat plate 23. Further, each elastic member 22 has two rectangular hollow holes 22a in the left and right portions respectively, whereby the elastic member 22 deforms in response to an external force as the upper faces 22b and the lower face 22c are always maintained to be in parallel. The number of hollow hole 22a may be one, but by forming two hollow holes 22a in the left and right portions respectively as shown in FIG. 2, parallel is more securely maintained at the time of deformation. Further, the elastic member may be provided with two additional hollow holes 22a in front and back portions respectively, so that it has a parallel flat plate structure having four hollow holes 22a.

On the top of the elastic member 22, a pressurizing plate 21 is placed. The pressurizing plate 21 is a common flat plate for all molds 3 to be pressurized at the same time by a single pressurizing apparatus 4, and on the top face of the pressurizing plate 21, the pressurizing apparatus 4 is attached. The pressurizing apparatus 4 may be an existing and conventionally used apparatus, which has, for example, a low friction cylinder 41 having a thrust of 4.9 KN and pressurizes in a vertical direction by a tool guided by a guide 42.

By the above-mentioned structure, the lower face of the pressurizing plate 21 and the movable flat plate 23 for pressurizing the molds 3, are always maintained to be in parallel during a pressurizing step, and variation of dimensions of molds in vertical direction is absorbed elastically so that the molds are pressed with a constant pressure, whereby the molds 3 are pressurized in parallel and evenly. Accordingly, the distance between molding faces of the top mold 31 and the bottom mold 33 becomes always constant, and axes of the top mold and the bottom mold are aligned into a single line, whereby it is possible to mold products having high precision optical performance. Thus, by the construction that the elastic member 22 deforms vertically with its parallelism maintained, difference of dimensions of molds 3 can be absorbed and dimensions of products can be always maintained to a predetermined dimension. Accordingly, it is possible to pressurize a plurality of molds 3 by a single pressurizing apparatus 4 at the same time to mold a plurality of precision optical elements.

Here, the elastic member 22 is disposed in the upper side of the molds 3 in the above example, but it may be disposed in the lower side of the molds 3.

Further, by disposing an elastic member 22 and a movable flat plate 23 for each mold 3, it is possible to pressurize an optional number of at least 2 of molds 3 at the same time.

Further, the structure of the elastic member 22 does not have to be the above-mentioned parallel flat plate structure and it may be such a structure that a pressurizing face is maintained to be parallel by a combination of link structures, or may be another structure which deforms with its top and bottom faces maintained to be in parallel.

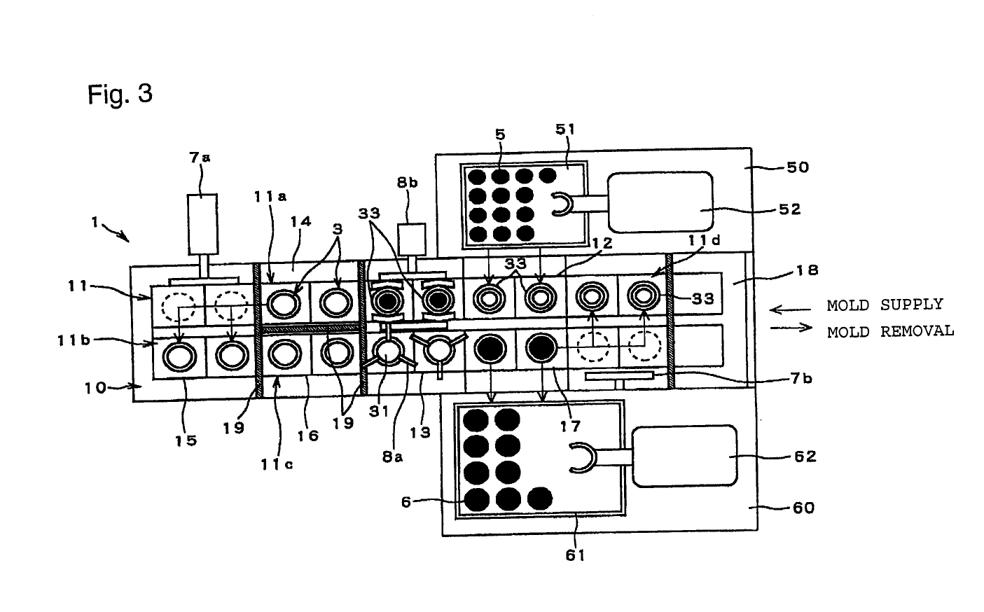

FIG. 3 shows an example of production apparatus of optical elements employing the molding apparatus of FIG. 2. The construction of entire production apparatus is described with reference to FIG. 3.

A production apparatus 1 for optical element comprises these chambers that are a chamber 10 (sealing chamber) accommodating a conveying path 11, a molding material chamber 50 for collecting and accommodating molding materials 5, and a product chamber 60 for collecting and accommodating products 6, and each of these chambers is filled with a non-oxidative atmosphere such as nitrogen atmosphere. Here, these three chambers may constitute a common single sealed chamber. In the molding material chamber 50, a molding material tray 51 on which molding materials 5 being glass balls are placed, and a molding material supply robot 52 for supplying the molding materials 5 to a predetermined position in the conveying path 11, are provided. In the product chamber 60, a product tray 61 for placing press-molded products 6 being molded optical elements, and a product retrieving robot 62 for taking out a molded product 6 from a mold and arranging it on the product tray 61, are provided.

In the chamber 10, a conveying path 11 comprising two rows that are an outgoing path 11a (an upper row in the figure) for conveying a mold 3 in which a molding material 5 is set, and a returning path 11c (lower row in the figure), are provided, and the conveying path 11 is partitioned into portions corresponding to process steps by partition walls 19 having heat insulation properties. In this Example, two molds arranged in parallel in a conveying direction are grouped and a space corresponding to a group of molds constitute one section.

The outgoing path 11a and the returning path 11c are connected each other by connecting paths 11b and 11d at their left and right ends respectively. The connecting path 11b in the left side constitutes a molding zone 15. In the molding zone 15, a group (2 pieces) of molds are conveyed from the upper section to the lower side in the figure by a mold conveying apparatus 7a. In the lower section, a group (2 pieces) of molds are pressurized at the same time by the above-mentioned molding apparatus 2 shown in FIG. 2, and 2 pieces of molded products are obtained.

Adjacently to the molding zone 15, a heating zone 14, a mold reassembly zone 13 adjacent thereto, and a molding material supply zone 12 adjacent thereto, are constituted in the outgoing path 11a. Meanwhile, in the returning path 11c adjacent to the molding zone 15, a cooling zone 16, a mold reassembly zone 13 adjacent thereto, and a product retrieving zone 17 adjacent thereto, are constituted. In the connecting path 11d at the right end, a group (2 pieces) of bottom molds 33 from which products 6 are taken out, are conveyed from a section in the returning path 11c in the lower side to a section in the outgoing path 11a in the upper side by a mold conveying apparatus 7b.

A mold exchange chamber 18 is provided at the right end portion of the conveying path 11 in FIG. 3, and when a trouble occurs to a mold or a mold needs to be cleaned, the mold is conveyed to the mold exchange chamber to be replaced. Accordingly, the mold exchange chamber 18 is not used in a normal molding process. An in-out port between the mold exchange chamber 18 and the outside is, for example, provided with a double door so that no air enters into the chamber 10.

A mold 3 to which a series of production process is completed, is conveyed from the cooling zone 16 to the mold reassembly zone 13, and a top mold 31 is removed from the mold 3 by a chuck 8a in the mold reassembly zone 13. The mold 3 from which the top mold is removed, is subsequently moved to the product retrieving zone 17, and a molded product 6 is taken out from the mold. The empty bottom mold 33 is conveyed to a connecting path 11d at the end of the returning path 11c, and further conveyed to the outgoing path 11a side. A group of bottom molds 33 sent to a section at the right end of the outgoing path 11, are further sent to a molding material supply zone 12. This feeding operation in the outgoing path 11a is carried out together with other molds by a mold conveying apparatus, not shown, for carrying out conveyance in an outgoing path 11a direction. The returning path 11c is also the same in this respect.

In the molding material supply zone 12, a molding material 5 is set on the empty bottom mold 33. Subsequently, in the mold reassembly zone 13, a top mold 31 removed in a lower section in the returning path 11 side, is fit onto the bottom mold 33 in which a molding material 5 is set. Then, the mold is heated in the heating zone 14, and subjected to press-molding in the molding zone 15.

From now, production sequence of optical elements by a production apparatus 1 shown in FIG. 3, is further described.

Removal and attachment of a top mold 31 are carried out by a chuck 8a in the mold reassembly zone 13. Namely, from a mold 3 conveyed from the cooling zone 16, a top mold 31 is removed and attached onto a bottom mold 33 in a section on the outgoing path 11a in the upper row in front of the heating zone 14. Before the top mold 31 is attached, the bottom mold 33 of a mold 3 is centered by a mold centering apparatus 8b, and then, the top mold 31 is attached, whereby their axes are aligned to each other.

After the top mold 31 is removed in a section in the returning path 11c in the lower row in the mold reassembly zone 13, the counterpart bottom mold 33 is conveyed one section length in right direction in the figure together with other molds. Then, in the product retrieving zone 17, a product 6 is suctioned and taken out by a product retrieving robot 62, and placed on a product tray 61. Thereafter, the bottom mold 33 is further conveyed one section length, and conveyed through a connecting path 11d to the outgoing path 11a in the upper row by a mold conveying apparatus 7b. In the upper row, the bottom mold 33 is conveyed one section length in left direction, and a molding material 5 is placed on the bottom mold 33 by a molding material supply robot 52 in the molding material supply zone 12. The bottom mold 33 is further conveyed one section length in left direction, and in a section in the outgoing path 11a side in the upper row in the mold reassembly zone 13, the above-mentioned attachment of a top mold 31 is carried out.

The mold 3 assembled by attaching the top mold 31 in the mold reassembly zone 13, is conveyed to the heating zone 14. In the heating zone 14, the mold 3 is heated to a temperature at which the molding material 5 being a glass ball becomes soft enough to be moldable by pressurizing. A molding zone 15 is provided adjacently to the heating zone 14. The mold 3 to which the treatment in the heating step is completed, is conveyed to the molding zone 15. Feeding from a section in the upper row in the molding zone 15 to a section in the lower row, is carried out by a mold conveying apparatus 7a, and in the section in the lower row, a group (2 pieces) of molds 3 are subjected to press-molding in parallel at the same time by the above-mentioned molding apparatus 2 shown in FIG. 2, to form products 6 having predetermined dimensions.

The mold 3 after the molding is conveyed to a cooling zone 16 provided adjacently to the molding zone 15. In the cooling zone 16, the mold 3 is cooled to a suitable temperature at which the quality of product 6 is stabilized. The mold 3 after the cooling is conveyed to the mold reassembly zone 13. A series of these conveying operations are carried out by four conveying means that are mold conveying apparatuses, not shown, for the outgoing path 11a in the upper row and for the returning path 11c in the lower row respectively, and mold conveying apparatuses 7a and 7b for connecting paths 11b and 11d in left and right ends respectively, and the series of conveying operations are each individually controlled or simultaneously controlled so as to carry out conveyance in a counterclockwise direction.

In such a production apparatus 1 for mass production, by employing the molding apparatus of the present invention, a plurality of optical elements are molded simultaneously with high precision.

### INDUSTRIAL APPLICABILITY

The present invention can be applied to a molding apparatus for molding a product by press-molding a molding material disposed in a mold.

The entire disclosure of Japanese Patent Application No. 2005-192528 filed on Jun. 30, 2005 including specification, claims, drawings and summary is incorporated herein by reference in its entirety.

What is claimed is:

1. An apparatus for molding optical element, which comprises a pressurizing apparatus for pressurizing a mold constituted by a top mold, a bottom mold and a body mold and in which a molding material is disposed, in a vertical direction to form an optical element; the apparatus for molding optical elements being characterized by further comprising a pressuring plate attached to a leading edge of the pressurizing apparatus, a flat plate movable in the vertical direction for pressurizing the mold, and an elastic member disposed between the pressurizing plate and the flat plate, and elastically deformable with its top face and bottom face always maintained to be parallel with each other.

2. The apparatus for molding optical element according to claim 1, wherein the flat plate and the elastic member are disposed for each mold and a plurality of molds are pressurized simultaneously by the single pressurizing plate attached to the single pressurizing apparatus.

3. The apparatus for molding optical element according to claim 1, wherein the elastic member has a parallel flat plate structure.

4. The apparatus for molding optical element according to claim 3, wherein the elastic member having a parallel flat plate structure has two rectangular hollow holes in the left and right portions respectively, whereby the elastic member deforms with its top face and bottom face always maintained to be parallel with each other.

5. The apparatus for molding optical elements according to claim 1, wherein the elastic member is disposed in the upper side of the mold.

6. The apparatus for molding optical element according to claim 1, wherein the optical element is an optical lens and the apparatus for molding optical element is employed in a molding step in a production apparatus for the optical lens.

7. The apparatus for molding optical element according to claim 6, wherein the optical lens is an optical lens made of a glass or a plastic.

8. The apparatus for molding optical element according to claim 1, wherein the pressurizing plate, the flat plate, the elastic member and the mold is present in a non-oxidative atmosphere.
